(19) United States
(12) Patent Application Publication
(10) Pub. No.: US 2007/0030339 A1
(43) Pub. Date: Feb. 8, 2007

(54) Method, system and software for monitoring compliance

(76) Inventors: Nathaniel Findlay, Sillery (CA); Sebastien Tanguay, St-Jean-Chrysostome (CA); Marc Onigman, Lincoln, MA (US); Jean-Francois Jobin, St. Augustin-de-Desmaures (CA); Thomas O'Connell, Quebec (CA); Mathieu Corriveau, Quebec (CA); Martin Morency, Montreal (CA); Sebastien Boulanger, Quebec (CA)

Correspondence Address: FOLEY AND LARDNER LLP;SUITE 500, 3000 K STREET NW, WASHINGTON, DC, 20007, US

(21) Appl. No.: 11/356,447

(22) Filed: Feb. 17, 2006

Related U.S. Application Data
(60) Provisional application No. 60/654,518, filed on Feb. 18, 2005.

(51) Int. Cl. H04N 7/14

(52) U.S. Cl. 348/14.01

(57) ABSTRACT

A method, system, and software of providing dietary compliance includes receiving a message from a mobile device of a user, the message containing dietary data of the user. Indexing information and the dietary data is automatically extracted from the message and the dietary data is stored in a data store with the dietary data indexed by the user and the extracted indexing information. Online access to the stored dietary data is provided to the user and a dietitian.

### CROSS-REFERENCE TO RELATED APPLICATIONS

This application claims the benefit of priority under 35 U.S.C. §119(e) to provisional application Ser. No. 60/654,518 filed on Feb. 18, 2005, the disclosure of which is incorporated herein in its entirety.

### BACKGROUND OF THE INVENTION

One of the problems faced by users who consult experts or advisors is that it is very difficult and expensive for the expert or advisor to monitor the activities of the user after the initial contact or consultation. In particular, if the expert or advisor has provided advice or a plan for a user to perform specific tasks, it is very difficult for the expert or advisor to monitor compliance with the specific tasks that the user is expected to perform.

Furthermore, one of the problems with the inability of the expert or advisor to monitor the activities of the user is that the user's are often not as motivated to perform the tasks that are required based on the advice or consultation. Furthermore, even if they perform some of the tasks, the tasks may not be performed correctly and the incorrect or inadequate performance may not be corrected in the absence of any timely feedback from the expert or advisor.

In the field of diet and nutrition, a user may be provided a diet or nutrition plan by a dietitian. However, it is very difficult for the dietitian to monitor the daily diet of the user since the user has several meals per day and providing timely information on each of the meals is a chore for the user and for the dietitian to review. Furthermore, the user's often do not have the knowledge of the nutritional value of each of the items that they may be eating so that they may not be able to comply with the diet plan even if they had the desire to do so. Furthermore, in the case of diets, a user is constantly exposed to temptation each time they are exposed to food or snacks and users that are not strong willed may easily yield to temptation unless they are actively monitored by a dietitian. Furthermore, reporting portion sizes by users using traditional means is often very inaccurate since the perception of a portion size varies significantly from one person to the next.

### SUMMARY OF THE INVENTION

In certain embodiments, the present invention provides a computer implemented method of providing dietary compliance, including: receiving a message from a mobile device of a user, the message containing dietary data of the user; automatically extracting indexing information and the dietary data from the message; storing the dietary data in a data store, the dietary data indexed by the user and the extracted indexing information; and providing online access to the stored dietary data to the user and a dietitian.

In certain embodiments, the method further includes reviewing of the stored dietary data of the user by the dietitian, and providing online feedback to the user, by the dietitian, based on the review of the stored dietary data.

In certain embodiments, the step of providing online feedback comprises sending a message from the dietitian to the mobile device of the user and the message includes a video message.

In certain embodiments, the step of receiving a message from the mobile device of the user includes receiving an image taken by the mobile device of the user.

In certain embodiments, the mobile device is a camera phone.

In certain embodiments, the step of automatically extracting indexing information includes extracting one or more of an identifier of the mobile device, a password provided by the user, a date when the message was composed or sent, and a time at which the message was composed or sent.

In certain embodiments, the step of extracting indexing information and the dietary data includes processing an image in the received message to identify the food items and portion sizes thereof

In certain embodiments, the step of storing the dietary data includes storing the dietary data indexed by day, and by meals within a day, based on a date and time data included in the extracted indexing information.

In certain embodiments, the step of providing online access to the stored dietary data includes providing access controls on the dietary data that allows access only to the user and one or more dietitians authorized by the user.

In some embodiments, the access controls allow a user to specify other users who can access the dietary data.

In certain embodiments, the present invention provides a system for providing dietary compliance including: a data store; and a server unit configured to (1) receive a message from a mobile device of a user, the message containing dietary data of the user, (2) automatically extract indexing information and the dietary data from the message, and (3) store the dietary data in the data store, the dietary data being indexed by the user and the extracted indexing information. The server unit is configured to provide online access to the stored dietary data of the user to the user and a dietitian.

In certain embodiments of the system, the server unit is configured to provide feedback to the user by sending a video message from the dietitian to the mobile device of the user.

In certain embodiments of the system, the mobile device of the user is a camera phone.

In certain embodiments of the system, the received message comprises an image taken by the mobile device of the user.

In certain embodiments of the system, the indexing information extracted by the server unit includes one or more of an identifier of the mobile device, a password provided by the user, a date when the message was composed or sent, or a time at which the message was composed or sent.

In certain embodiments of the system, the server unit stores the dietary data in the data store in a journal format with the dietary data indexed by day, and by meals within a day, based on a date and time data included in the extracted indexing information.

In certain embodiments, the present invention provides a computer readable medium having program code recorded thereon that, when executed on a computing system, facilitates dietary compliance, the program code including: code for receiving a message from a mobile device of a user, the message containing dietary data of the user; code for automatically extracting indexing information and the dietary data from the message; code for storing the dietary data in a data store, the dietary data indexed by the user and the extracted indexing information; and code for providing online access to the stored dietary data to the user and a dietitian.

In certain embodiments, the program code further includes code for reviewing the stored dietary data by the dietitian, and code for providing online feedback to the user, from the dietitian, based on the review of the stored dietary data.

In certain embodiments, the present invention provides a computer implemented method of providing dietary compliance, including the steps of: registering, by a user, with a remote server unit for monitoring of dietary data by a dietitian; generating dietary data, by generating an image of food, using a mobile device each time the user eats any food; and sending the dietary data to the server unit, by the mobile device, each time the user eats any food.

Certain embodiments of the method further include receiving online feedback, from a dietitian who has reviewed the dietary data, on the mobile device of the user.

Certain embodiments of the present invention provide a computer implemented method of providing activity compliance, including the steps of: receiving a message from a mobile device of a user, the message containing activity data of the user; automatically extracting indexing information and the activity data from the message; storing the activity data in a data store, the activity data being indexed by the user and the extracted indexing information; and providing online access to the stored activity data to an expert in the activity.

In certain embodiments, the activity includes one of a golf swing, fashion related style analysis, monitoring outpatient medical procedure follow-ups, or monitoring health related parameters.

### BRIEF DESCRIPTION OF THE DRAWINGS

The accompanying drawings, which are incorporated in and constitute a part of the specification, illustrate embodiment(s) of the invention, and together with the general description given above and the detailed description of the various embodiment(s) given below, serve to explain various aspects of the invention.

FIG. 1 is a flow diagram that illustrates the process flow of one embodiment in which a user sends dietary information to a server unit for review by a dietitian.

FIG. 2 is flow diagram that illustrates one embodiment of a user registering with the server unit for nutrition compliance and monitoring.

FIG. 3 is a flow diagram that illustrates the process of providing a food journal for a user.

FIG. 4 is a flow diagram that illustrates the process of an expert monitoring compliance with an activity to be performed by a user.

FIG. 5 is a diagram that illustrates the components of the system that implements one embodiment of the present invention.

FIG. 6 is a diagram that displays a user interface presented by the server to the user in one embodiment.

FIG. 7 is a diagram that illustrates a food journal display in one embodiment.

FIG. 8 illustrates an interface for entering biometric data in a mobile phone.

FIG. 9 illustrates a feedback video message from a dietitian.

FIG. 10 is an exemplary user interface to search for a buddy.

FIG. 11 is a exemplary user interface to invite a buddy.

FIG. 12 illustrates a generic computing system diagram that may be used with certain embodiments.

FIG. 13 is a flow diagram illustrating one embodiment of a registration process from a mobile device.

### DETAILED DESCRIPTION OF THE VARIOUS EMBODIMENTS

In a general aspect, the present invention is directed to an expert remotely monitoring the compliance of a user with activities that are to be performed by the user on a regular basis. Accordingly, the present invention encompasses all such activities in which the remote activities of a user can be monitored by an expert.

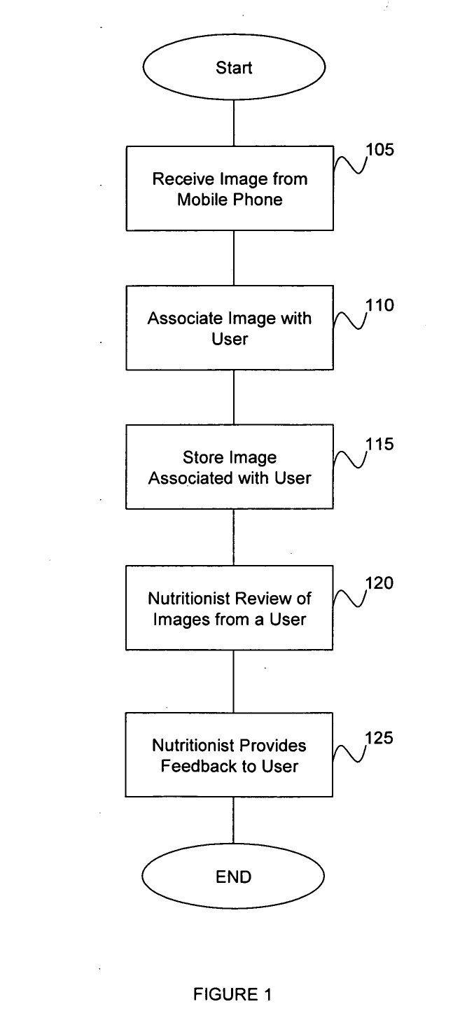

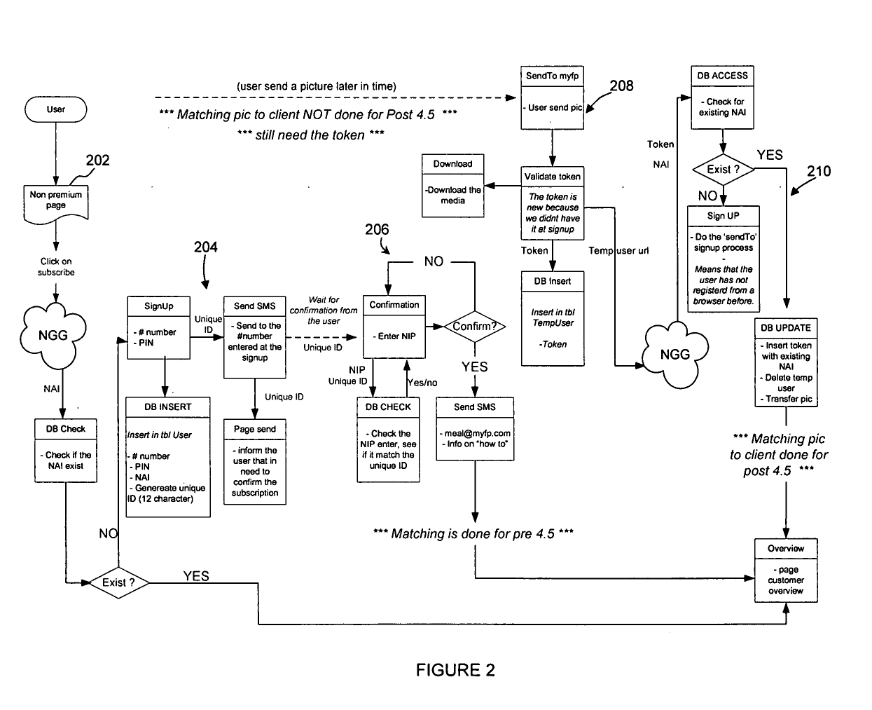

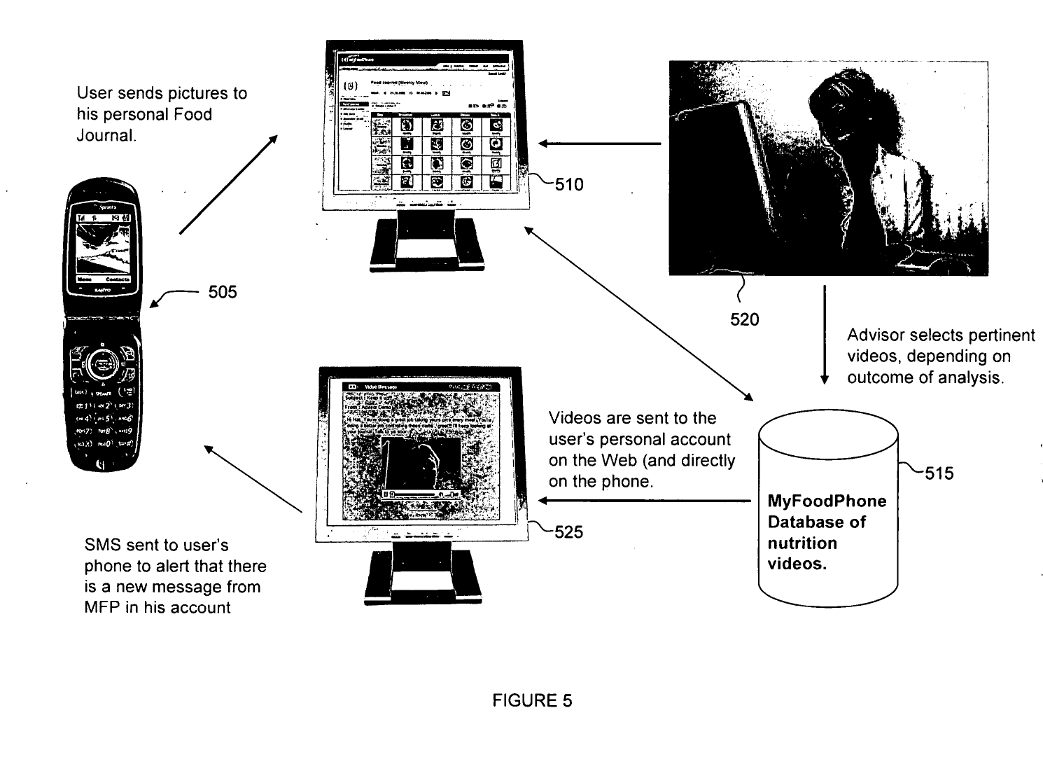

FIG. 1 discloses the process steps in one embodiment of the present invention in which a user's dietary data is remotely monitored by a dietitian. As seen in FIGS. 1 and 5, in step 105, a server 510 receives an image from a mobile device, such as a mobile camera-phone 505. It should be noted that these figures are exemplary only and one skilled in the art would recognize various alternatives and modifications all of which are considered as a part of the present invention. A user uses the mobile camera-phone 505 to take a picture of every meal he eats and send the picture via a message from the phone 505 to the server 510. As discussed further herein with respect to FIG. 2, the user registers with the server 510 before starting the process of sending photos of his food to the server 510.

In step 110, the server 510 associates the received message (including the image of the food) with a particular user. This association with the user is done based on the information acquired by the server during the registration process of the user. For example, the registration process may register an identifier of the mobile device of the user and associate the mobile identifier with the user in a table or other index stored at the server 510. Alternatively, the process of sending the message from the user may include providing an userid and/or a password which is then used to identify the user by the server 510.

In step 115, the received image is stored in a data store, such as the database 515, associated with the user. It should be noted that the database 515 could be a separate database (as shown in FIG. 5) or could be located in the server 510 or could be located remotely in a database server farm or other location as would be recognized by those skilled in the art. All such configurations would work with the various embodiments of the present invention.

As part of the steps 110 and 115, the server would also automatically extract indexing information from the received message so that the received image could be indexed and stored in a manner that is useful for monitoring purposes. For example, in addition to extracting information that identifies the user (for example, the mobile device identifier), the server is also programmed to extract the date and time at which the received message was either composed or sent. Typically, this information is available as header information associated with the message and the server would parse the header information to locate the date and time information and associate the received image with the date and time. The image is then stored in the database indexed by the date, and the time may be used to further classify the image as representing food that is eaten at specific meals. For example, any time between 6:00 AM-10:00 AM (based on the time of message sender) could be classified as breakfast, 12-2:00 PM could be classified as lunch while 6-10 PM could be classified as dinner while all other times could be classified as a snack. Therefore, the server 510 classifies the image as representing food eaten in specific meals on specific days and this classified image data is stored in the database 515.

In step 120, the dietitian can review the classified images of the food eaten by a user and in step 125, the dietitian can provide feedback to the user. In certain embodiments, only specific dietitians are provided access to the dietary data (i.e., classified images) while in alternate embodiments, any dietitian with access to the server system 510 may access the dietary data for any user. For example, the server system may have specific dietitians who come in on specific days and provide feedback on all users that are due feedback on that specific day.

The periodicity of the feedback by the dietitian is customizable. In some instances, the dietitian may look at the dietary data for each user asynchronously on a daily basis while in other instances a weekly review may be sufficient

In certain embodiments, the dietitian's review of the food data may be assisted by image processing and pattern recognition algorithms that process the image and try to match patterns using techniques that are within the abilities of those skilled in the art of image processing. For example, the image processing algorithms might segment the image to identify the discrete food items and compare the shapes or other parameters of the identified discrete food items to images or parameters of known food items. In addition, by comparing the size of the identified food item to the size of an average plate (for example), an estimate of the portion size can also be made. In this embodiment, the additional data from the image processing is also stored in the database associated with the specific images which are both correlated to both the specific user and the food journal (that is, the specific meals within a day). In addition, the database 515 includes a database containing publicly available nutrition information or alternatively the server 510 may access publicly available sources of nutritional information. Therefore, if the food item can be identified and a portion size estimated (or alternatively, a standard portion size may be used as an approximation), the system accesses the nutrition database and further annotates the user's food journal with nutrition information based on the identified food items. For example, the annotated information may include a count of the calories, the grams of fat, or other nutritional data that is useful to the dietitian and/or the user.

Once the dietitian completes his review based in the food journal, the system allows the dietitian to provide meaningful feedback to the user. The dietitian 520 may provide text, audio, or video feedback and arrange for the feedback to be sent to the user. In certain embodiments, the dietitian 520 may have access to a pre-recorded set of standard video or audio messages stored in the database 515 and all he has to do is to select the pre-recorded message which is most appropriate for a particular user whose food journal has been reviewed by the dietitian. Alternatively, the dietitian station 520 may be provide with a video camera by which a custom message may be recorded and sent to the user.

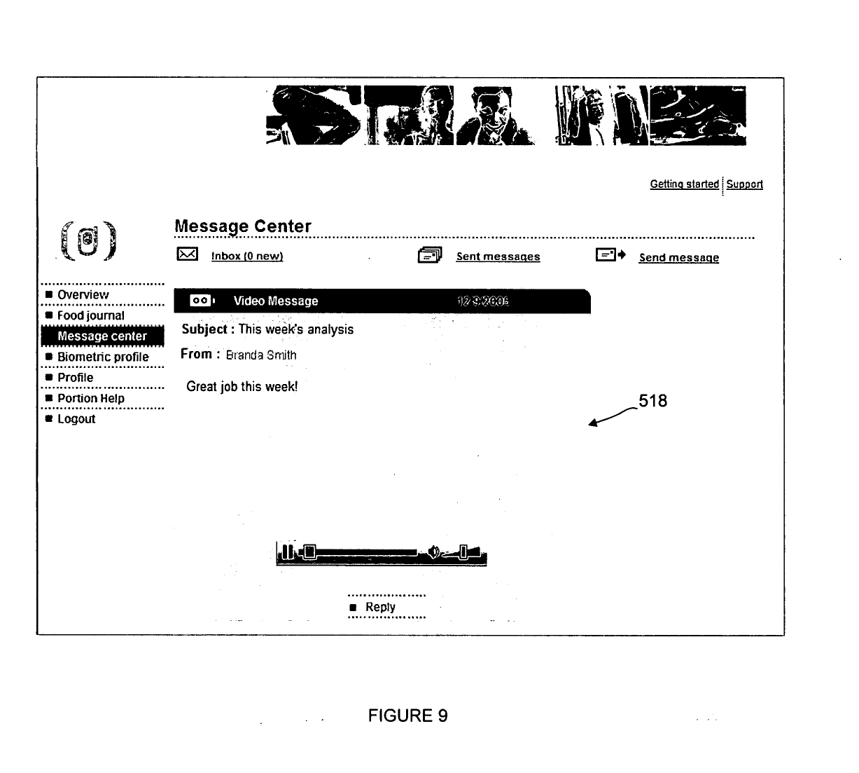

The feedback message may be stored as a message for the user on the server and/or sent to the user's mobile device 505 as a message. Alternatively, the complete feedback message can be stored as a message to the user in the server 510 while an alert message may be sent to the mobile device 505 of the user. FIG. 9 shows the example of a video feedback message 518 that may be provided to the user either on the user's mobile device or stored as a message on the server which the user can access whenever the user accesses the server 510 with a conventional web browser.

If the feedback message is sent to the mobile device 505 of the user, the user has the option of viewing the message on the screen or display of the mobile device (or listen to an audio message), or the user may log in to the server 510 and review all his messages when online accessing the server.

FIG. 2 is a flow diagram that illustrates some the processes associated with a user registering for the dietary monitoring service for the first time. The user may initiate the registration process in step 202 through a web interface that connect to the server 510. In the processing flow designated as 204, the user provides a telephone number and/or other identifier (NAI) for the mobile device 505 and/or another identifier (PIN) for use by the user when accessing the server 510 using a browser (either HTML or WAP browser) and in step 206, the user is required to go through an affirmative interaction to confirm his registration. In steps 208 and 210, the user provides a picture which is matched to the user's profile that has been registered and the registration process in completed. In particular, if the mobile device service provider provides an alternative mechanism for providing a photo (with a unique token instead of by e-mail or by telephone number), the token is received when the user sends his first photo and the token is then stored in the database correlated to the user. Therefore, the system can identify and associate a message or photo to a user provided the message or photo is accompanied by one or more of a PIN, a NAI, a telephone number, or a token.

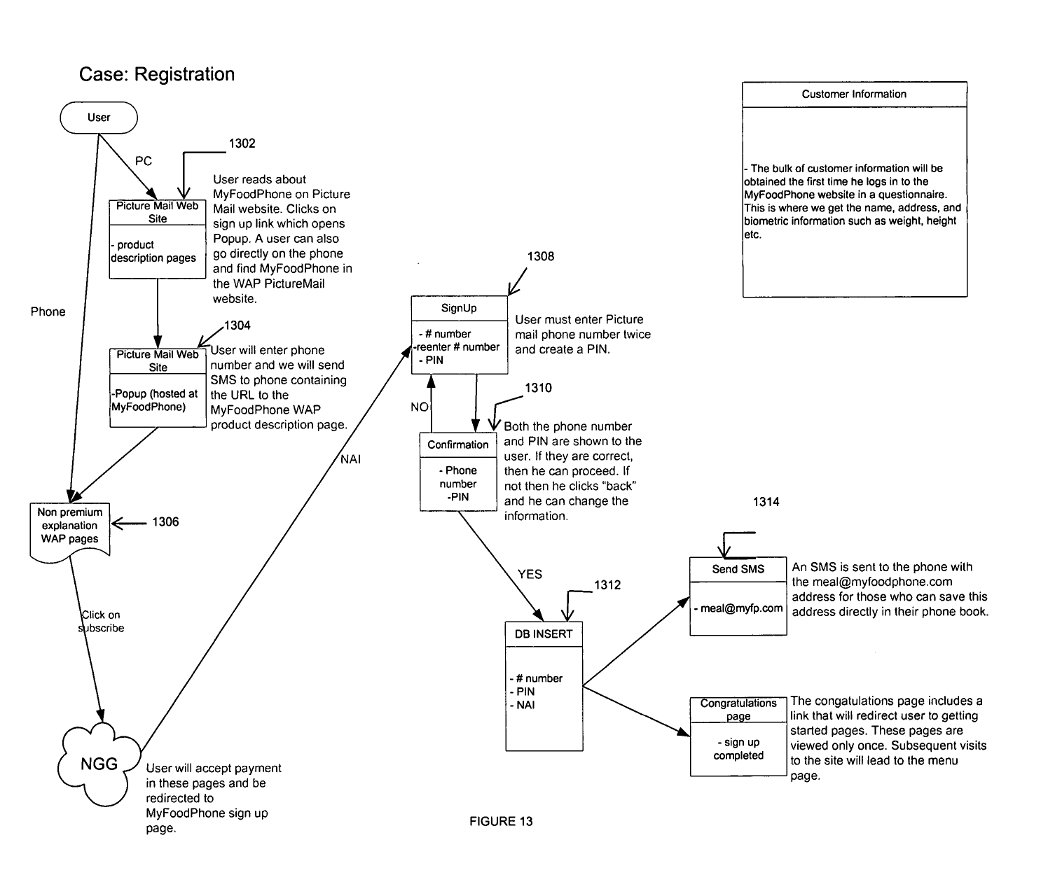

FIG. 13 is another embodiment of the registration process in which the entire registration is performed by a user using the mobile device 505. For example, in steps 1302 the user uses a WAP browser (which is exemplary of a display on the mobile device) to initiate registration with the server 510. After the payment processing is completed in step 1306, the user enters a telephone number and creates an identifier (PIN) in step 1308. Once the user confirms the telephone number and the PIN in step 1310, the telephone number, the PIN, and a mobile device identifier (NAI) is stored in a database at the server correlated with the user. Thereafter, in step 1314, the user is sent a message on his mobile device so that the user can save the address they need to use to send a message from the mobile device 505 to the server 510 with the message containing information on the monitored activity (for example, the diet) of the user.

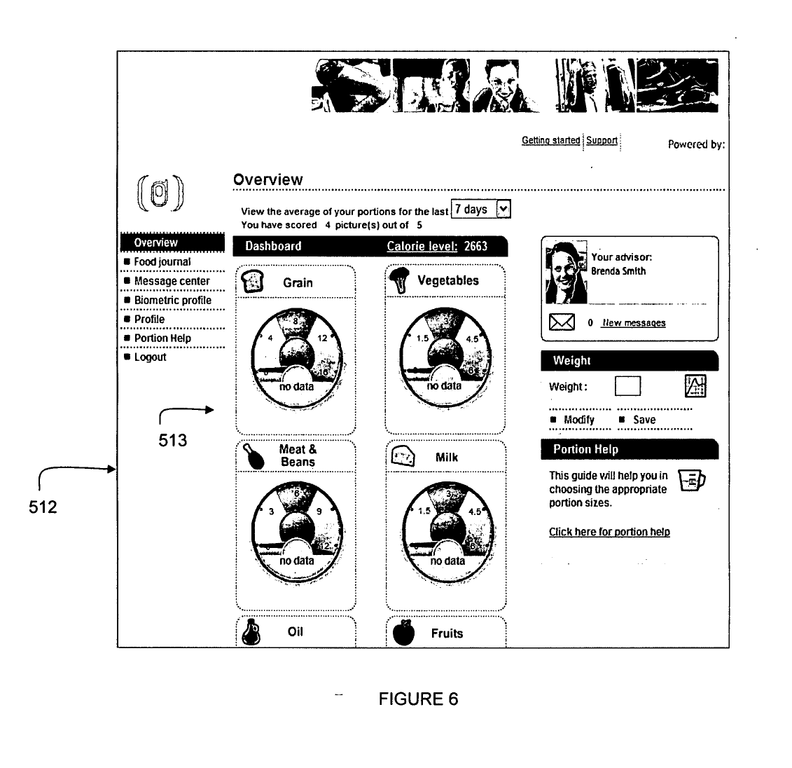

FIG. 6 is a diagram illustrating a user interface 512 that is provided to the user when he logs in to the server 510. This interface 512 may be provided on a conventional web browser or a modified browser suitable for display on mobile terminals if the user logs in using a mobile terminal or device. As shown, the user interface 512 may provide the user with dashboard displays 513 that graphically illustrates the food consumed (in percentages or servings) of the various food groups compared to what the user is expected to eat. The percentages may be based on the user's daily consumption (on a particular day) or may be based on his average consumption over a week (or other similar time period).

The dashboard displays 513 are an innovative way in which the user can conveniently view a personalized daily portion by food group (grain, vegetables, meats, and dairy, for example). A dial, or other similar display, indicates where the user is on the consumption of each food group on a daily basis. The consumption indicated (by the dial) may be on a the consumption of a particular day or may be based on an average daily consumption over a period of time (for example, based on an average over a 7, 14, 21, or 30 day period).

It should be noted the display 512 could be viewed on a standard web interface that connects to the server 510 or could also be viewed on display on the mobile device 505 which connects to the server 510 using protocols (such as WAP) which are suitable for use on mobile (i.e. wireless) devices.

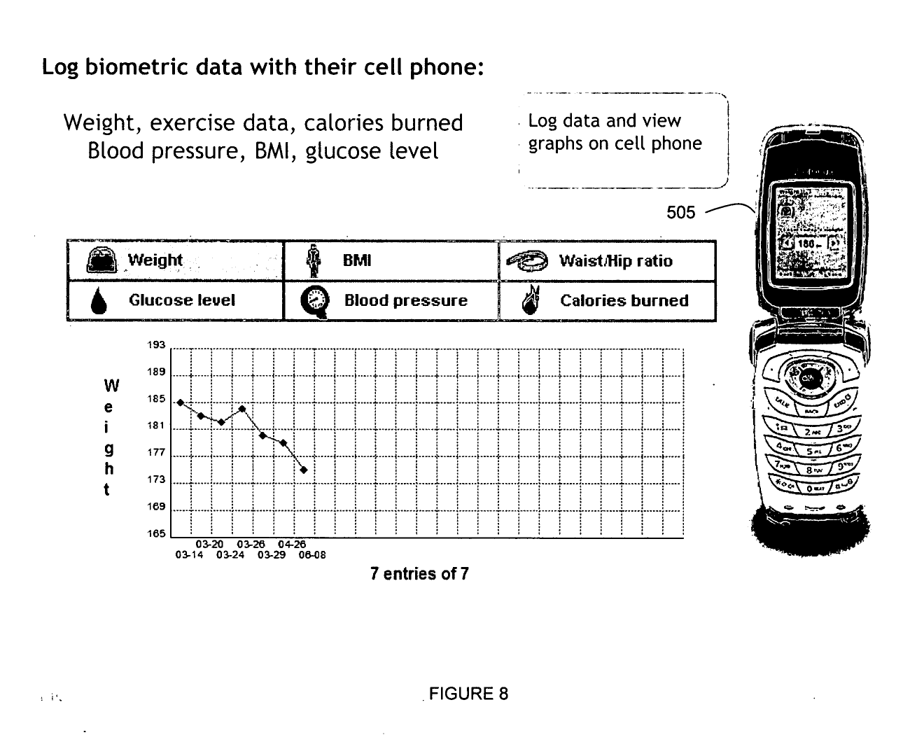

FIG. 8 displays an interface that may be used by the user to enter data that may also be stored by the server together with the user's information and also indexed by the date and time the data is received. Typically, this data may be entered by the user by using a custom interface provided on the mobile phone 505. Alternatively, the data may also be entered on an web interface that connects to the server 510. The data that may be entered by the user may include the weight, the BMI (which may be automatically calculated based on the entered weight and the user's height which may be input initially), measurements of the waist/hip ratio, the glucose level, the blood pressure, or even calories burned (for example, based on an activity chart).

Alternatively, the data (blood pressure, glucose level, etc.) may be automatically sensed by a sensor that is integrated with the mobile device. Such integrated devices are available from commercial sources. In another alternative, the sensors (for detecting blood pressure, glucose, weight etc.) may connect wirelessly to the mobile device 505 using Bluetooth or Wifi protocols and the sensed data may be transmitted to the mobile phone for onward transmission to the server 510.

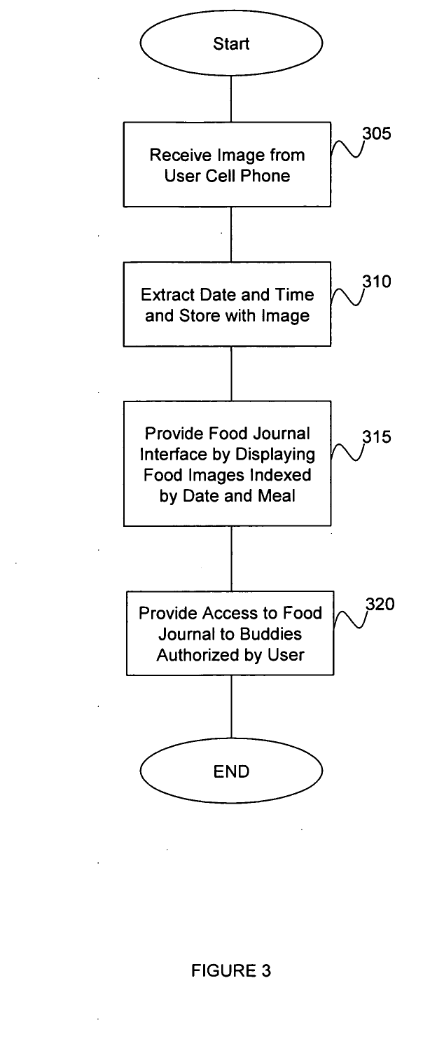

FIG. 3 illustrates the steps in the setting up of the food journal for a user. In step 305, the message containing food data (or image) is received at the server from the mobile device (or camera phone). In step 310, the server extracts the date and time from the header of the message so that the food data can be stored in a journal form in which the food data is stored correlated to a date and a meal. As discussed earlier herein, the logic for associating a food data may be based on the time data included in the header of a message. Alternatively, if the food image data has a time stamp associated with it, that time stamp may be used to determine which meal and which date a particular food data (or image) belongs to.

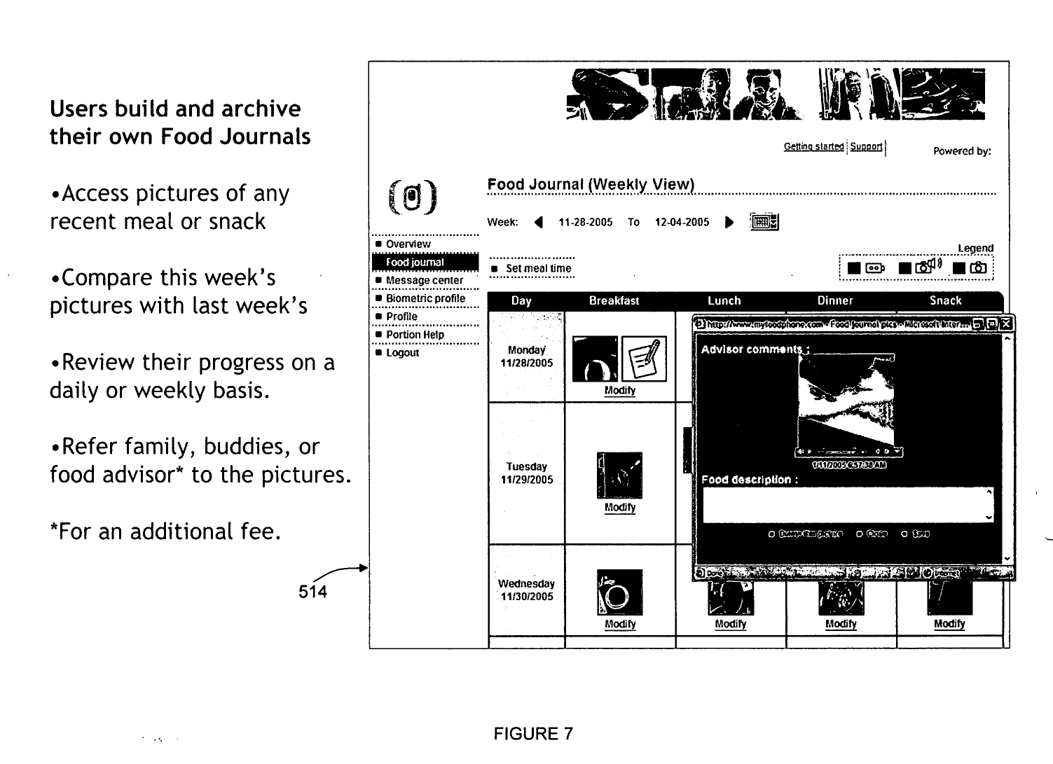

In step 315, as illustrated in the FIG. 7, a display 514 shows the user's food consumption in the form of the journal in which the dietary data is shown classified by day and by meals within a day. The dietary data shown in the journal includes the food data (or images) sent by the user using his mobile device (for example, his mobile camera-phone) and may also include any annotations that have been automatically determined by the system (for example, by image processing) or provided by a dietitian.

The access to the food journal of a user is typically restricted to the user and one or more authorized dietitians. However, as shown in the step 320, the user may allow access to his food journal to one or more buddies (who may then reciprocally allow the user to view their journals).

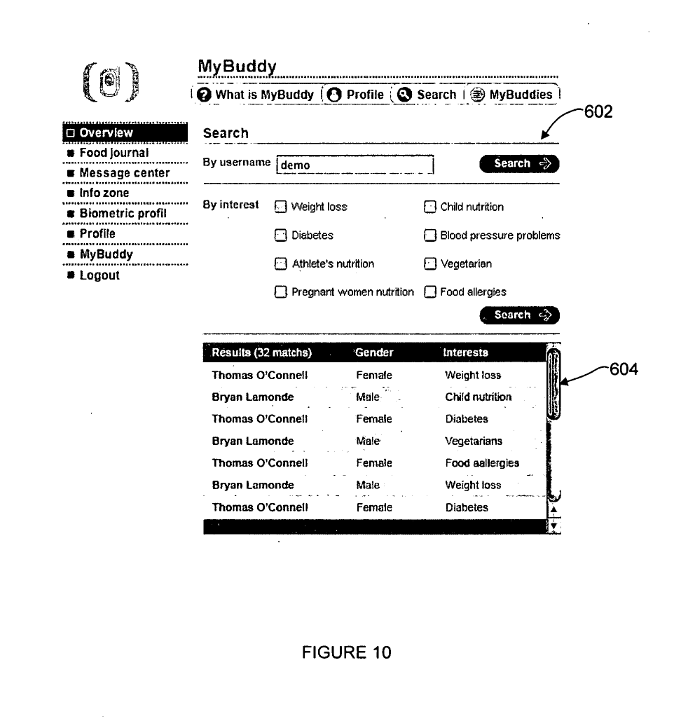

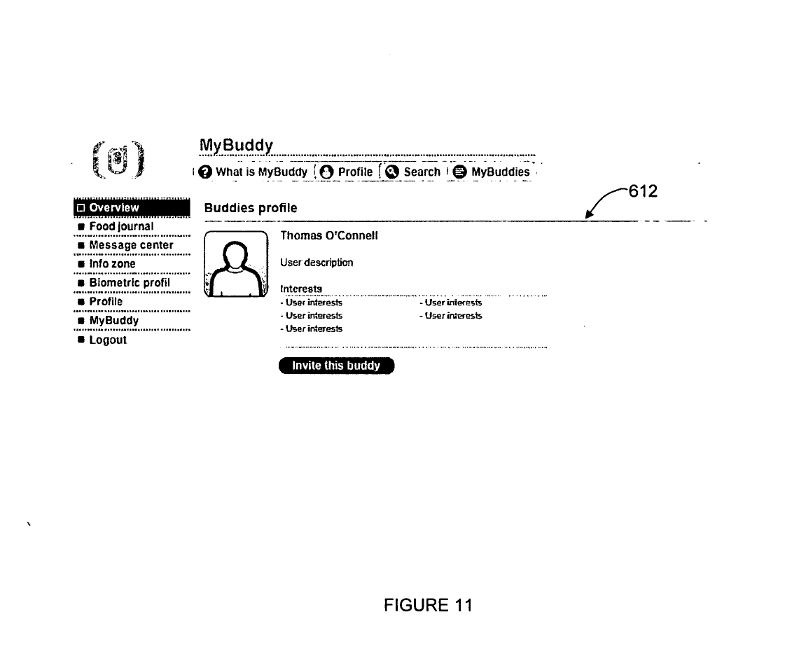

FIGS. 10 and 11 show the search displays that a user may use to identify and invite a buddy. As shown in the section 602 of the display in FIG. 10, the user may search for buddies based in the type of interest that users have in using the system. Based on the criteria entered by the user, a list of other users who match the criteria of the user is provided to the user in section 604 of the display in FIG. 10. The user may then browse the profile 612 (as shown in FIG. 11) of the users that have met his criteria and decide whether to invite them as buddies. If the user elects to invite a buddy, a message is sent to the other prospective buddy (either on the website and/or to the mobile device), so that the prospective buddy has the option to accept or decline the invitation.

If the prospective buddy, accepts the invitation, the contact details of the buddies may be provided to each other and the access controls are adjusted so that each buddy has access to the other buddies food journals. Furthermore, the buddies may also have a special area where they can leave messages or provide comments to each other.

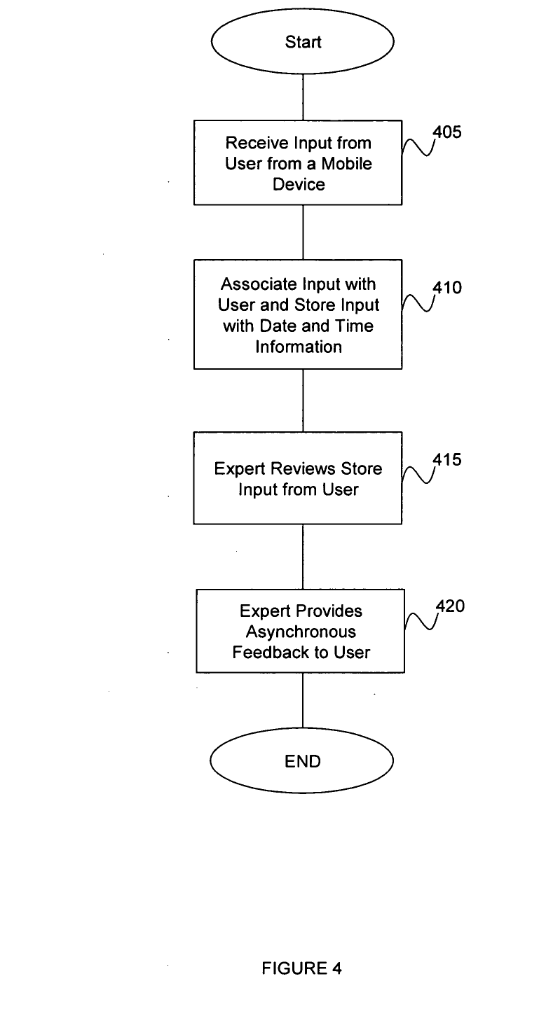

FIG. 4 is a flowchart that illustrates the process of an expert receiving activity information of a user that is being advised or monitored by the user. In step 405, the user provides input based on his activity to the a server by using his mobile device to send a message. For example, the mobile device may be a mobile camera-phone which takes pictures of the activity and sends the picture or message to a server with which the user has pre-registered.

Some example of the activities that may be photographed may include a golf swing (to be analyzed by a golf “swing doctor”), wearing a particular fashion outfit (to be analyzed by a fashion expert), a wound dressing or other periodic medical procedure (to be monitored by a doctor or a nurse), or even providing data or taking medications for diabetes, cardiac treatment, or high blood pressure (to be monitored by a doctor or a health care professional).

In step 410, the system associates the input data with the user and stores the input data further indexed by the date and time information that is automatically extracted from the input (for example, based on the header on a message). In step 415, the expert reviews the input asynchronously, and in step 420, the expert provides his feedback to the user either by a message (audio, video, and/or text message) to the mobile device and/or for access on the server.

Generalized Computing System Diagram

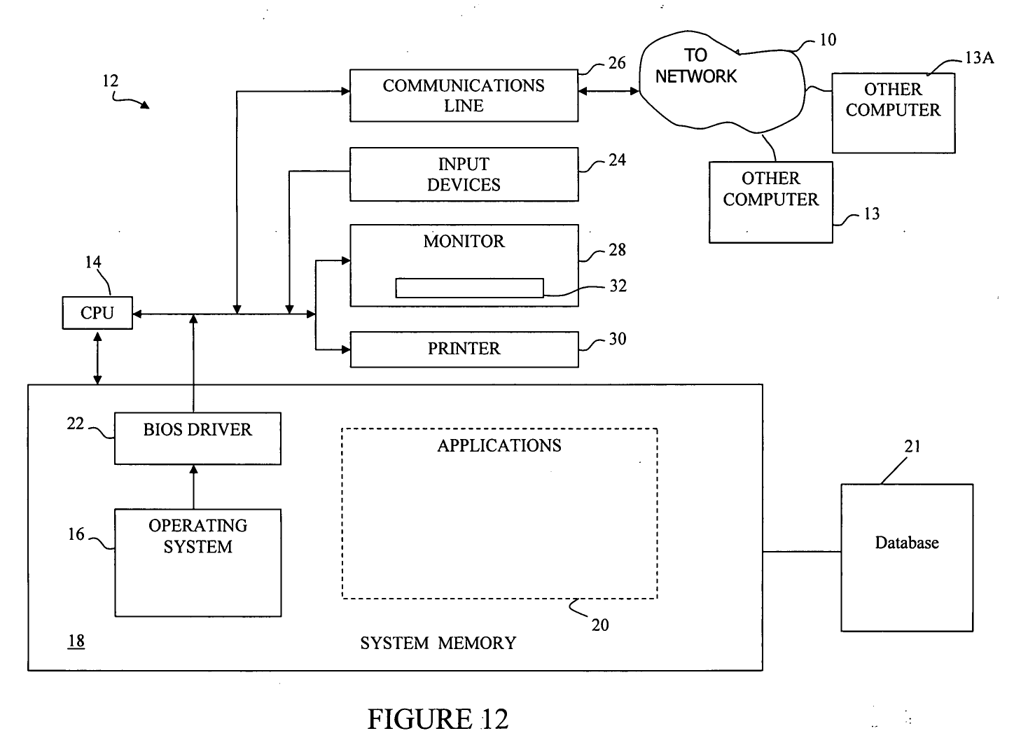

FIG. 12 illustrates the components of a generic computing system connected to a general purpose electronic network 10, such as a computer network. The computer network can be a virtual private network or a public network, such as the Internet. As shown in FIG. 5, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork, such as the Internet. Data is stored either in many local repositories and synchronized with a central warehouse optimized for queries and for reporting, or is stored centrally in a dual use database.

One skilled in the art would recognize that the foregoing describes a typical computer system connected to an electronic network. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of the present invention, discussed earlier herein. For example, such a computing system could be used to implement the method of monitoring dietary compliance (or tracking of activities by an expert) as discussed earlier herein with respect to FIGS. 1-4.

The present invention also contemplates providing computer readable data storage means with program code recorded thereon (i.e., software) for implementing the method steps described earlier herein. Programming the method steps discussed herein using custom and packaged software is within the abilities of those skilled in the art in view of the teachings disclosed herein.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein.

What is claimed is:

1. A computer implemented method of providing dietary compliance, comprising the steps of:
receiving a message from a mobile device of a user, the message containing dietary data of the user;
automatically extracting indexing information and the dietary data from the message;
storing the dietary data in a data store, the dietary data indexed by the user and the extracted indexing information; and
providing online access to the stored dietary data to the user and a dietitian.

2. The method according to claim 1, further comprising:
reviewing of the stored dietary data of the user by the dietitian; and
providing online feedback to the user, by the dietitian, based on the review of the stored dietary data.

3. The method according to claim 2, wherein the step of providing online feedback comprises sending a message from the dietitian to the mobile device of the user.

4. The method according to claim 3, wherein the message comprises a video message.

5. The method according to claim 1, wherein the step of receiving a message from the mobile device of the user comprises receiving an image taken by the mobile device of the user.

6. The method according to claim 5, wherein the mobile device is a camera phone.

7. The method according to claim 1, wherein the step of automatically extracting indexing information comprises extracting one or more of an identifier of the mobile device, a password provided by the user, a date when the message was composed or sent, and a time at which the message was composed or sent.

8. The method according to claim 1, wherein the step of extracting indexing information and the dietary data comprises processing an image in the received message to identify the food items and portion sizes thereof.

9. The method according to claim 1, wherein the step of storing the dietary data comprises storing the dietary data indexed by day, and by meals within a day, based on a date and time data included in the extracted indexing information.

10. The method according to claim 1, wherein the step of providing online access to the stored dietary data includes providing access controls on the dietary data that allows access to the user and one or more dietitians authorized by the user.

11. The method according to claim 10, wherein the access controls allow a user to specify other users who can access the dietary data.

12. A system for providing dietary compliance comprising:
a data store; and
a server unit configured to
receive a message from a mobile device of a user, the message containing dietary data of the user,
automatically extract indexing information and the dietary data from the message, and
store the dietary data in the data store, the dietary data being indexed by the user and the extracted indexing information,
wherein the server unit is configured to provide online access to the stored dietary data of the user to the user and a dietitian.

13. The system according to claim 12, wherein the server unit is configured to provide feedback to the user by sending a video message from the dietitian to the mobile device of the user.

14. The system according to claim 12, wherein the mobile device of the user is a camera phone.

15. The system according to claim 12, wherein the received message comprises an image taken by the mobile device of the user.

16. The system according to claim 12, wherein the indexing information extracted by the server unit includes one or more of an identifier of the mobile device, a password provided by the user, a date when the message was composed or sent, or a time at which the message was composed or sent.

17. The system according to claim 12, wherein the server unit stores the dietary data in the data store in a journal format with the dietary data indexed by day, and by meals within a day, based on a date and time data included in the extracted indexing information.

18. The system according to claim 12, wherein the data store comprises access controls on the dietary data so that access to the dietary data of a user is restricted to one or more of specific users and dietitians.

19. A computer readable medium having program code recorded thereon that, when executed on a computing system, facilitates dietary compliance, the program code comprising:
code for receiving a message from a mobile device of a user, the message containing dietary data of the user;
code for automatically extracting indexing information and the dietary data from the message;
code for storing the dietary data in a data store, the dietary data indexed by the user and the extracted indexing information; and
code for providing online access to the stored dietary data to the user and a dietitian.

20. The computer readable medium according to claim 19, further comprises:
code for reviewing the stored dietary data by the dietitian; and
code for providing online feedback to the user, from the dietitian, based on the review of the stored dietary data.

21. The computer readable medium according to claim 20, wherein the code for providing online feedback includes code that that generates a video message that is sent to the mobile device of the user.

22. The computer readable medium according to claim 19, wherein the code for receiving the message from the mobile device of the user comprises code that receives an image taken by the mobile device of the user.

23. The computer readable medium according to claim 22, wherein the mobile device of the user is a camera phone.

24. A computer implemented method of providing dietary compliance, comprising the steps of:
registering, by a user, with a remote server unit for monitoring of dietary data by a dietitian;
generating dietary data, by generating an image of food, using a mobile device each time the user eats any food; and
sending the dietary data to the server unit, by the mobile device, each time the user eats any food.

25. The computer implemented method according to claim 24, further comprising:
receiving online feedback, from a dietitian who has reviewed the dietary data, on the mobile device of the user.

26. A computer implemented method of providing activity compliance, comprising the steps of:
receiving a message from a mobile device of a user, the message containing activity data of the user;
automatically extracting indexing information and the activity data from the message;
storing the activity data in a data store, the activity data being indexed by the user and the extracted indexing information; and
providing online access to the stored activity data to an expert in the activity.

27. The method according to claim 26, wherein the activity comprises one of a golf swing, fashion related style analysis, monitoring outpatient medical procedure follow-ups, or monitoring health related parameters.
